(19) United States
(12) Patent Application Publication
(10) Pub. No.: US 2016/0139300 A1
(43) Pub. Date: May 19, 2016

(54) METHOD FOR PRODUCING A LOW TEMPERATURE GLASS PHOSPHOR LENS AND A LENS PRODUCED BY THE SAME

(71) Applicant: TAIWAN COLOR OPTICS, INC., Taichung (TW)

(72) Inventors: Wood-Hi Cheng, Taichung (TW); Yung-Peng Chang, Taichung (TW); Li-Yin Chen, Taichung (TW); Chun-Chin Tsai, Taichung (TW); Yi-Chung Huang, Taichung (TW); Wei-Chih Cheng, Taichung (TW); Jin-Kai Chang, Taichung (TW)

(21) Appl. No.: 14/542,374

(22) Filed: Nov. 14, 2014

(51) Int. Cl. G02B 1/02; F21V 5/00; C03B 19/06; C03C 4/12; C09K 11/02; C09K 11/77; C03C 3/087; F21V 5/04; C03C 19/00

(52) U.S. Cl. CPC G02B 1/02; F21V 5/04; F21V 5/004; C03B 19/063; C03C 19/00; C09K 11/025; C09K 11/7706; C03C 3/087; C03C 4/12; C03C 2204/00

(57) ABSTRACT

A method for producing a low temperature glass phosphor lens includes dry mixing a glass material and fluorescent powder to form a powdery or particulate mixture. The mixture is grinded to a diameter of 15-20 μm, obtaining uniformly mixed glass fluorescent powder. The glass fluorescent powder is hot pressed into a glass phosphor at a temperature of 500-1000° C. The glass phosphor is grinded and polished into a lens. The fluorescent powder can be a fluorescent material selected from the group consisting of yttrium aluminum garnet, nitride, and silicate. The glass material can be selected from the group consisting of a silicate system, a phosphor system, a borate system, and a tellurate system. The glass phosphor includes characteristics of both of glass and fluorescence. The glass phosphor can keep efficiency under the high heat generated by the chip of an LED.

### BACKGROUND OF THE INVENTION

1. Field of the Invention

The present invention relates to a lens that can be used in a white light illuminating module or used as a packaging structure of a light-emitting diode.

2. Description of the Related Art

Recently, white light emitting diodes have gradually replaced conventional lights and have received attention from the consumers due to the advantages of long service life, small volume, and excellent light emitting efficiency.

FIG. 1 shows a conventional white light emitting diode including a substrate 10, a short wavelength light emitting diode 11 mounted on the substrate 10, a color change medium 12 mounted on the short wavelength light emitting diode 11, and a packing element 13 for packaging the color change medium 12 and the short wavelength light emitting diode 11. The short wavelength light emitting diode 11 emits short wavelength light rays. The color change medium 12 is excited by the short wavelength light rays from the short wavelength light emitting diode 11 and emits complementary light rays that are complementary to the short wavelength light rays. The light rays and the complementary light rays form white light rays by the principle of light mixing. In a most common example, polymer fluorescent gel is applied on a blue chip such that a blue light turns into a white light source after passing through the polymer fluorescent gel as a result of light mixing. The polymer fluorescent gel includes fluorescent powder of yttrium aluminum garnet (YAG) and silica gel.

Generally, if the heat generated during light emission of a light emitting diode cannot be guided to the outside, the temperature of the interface of the light emitting diode will become too high and, thus, adversely affect the service life, the light emitting efficiency, and stability. For example, when a blue chip is used in a high luminance situation requiring a higher power, the heat generated on the surface of the blue chip causes rapid deterioration of the silica gel, leading to increased loss of lumen, severe chromaticity shift, and unstable quality of the lighting source.

On the other hand, since glass has excellent transmittance to light and can evenly be mixed with fluorescent powder, glass materials with better resistance to heat have been proposed to replace silica gel to mix with fluorescent powder for sintering, forming a glass phosphor with characteristics of both of glass and fluorescence. This significantly removes the inherent temperature limitations to polymer materials. The glass phosphor can be used as an LED packing material that is less easily to age under the heat energy from the LED chip.

However, the processing temperature of the glass materials are generally above 1000° C., which not only increases difficulties in the process but is apt to destruct the fluorescent property of the fluorescent powder during the high temperature process.

Thus, a need exists for a novel method for producing a low temperature glass phosphor lens and a lens produced by the method.

### SUMMARY OF THE INVENTION

An objective of the present invention is to provide a method for producing a low temperature glass phosphor lens and a lens produced by the method. A thermally stable glass phosphor lens produced at a low processing temperature is, thus, provided.

The present invention fulfills the above objective by providing a method for producing a low temperature glass phosphor lens. The method includes: (a) a mixing step including dry mixing a glass material and fluorescent powder to form a powdery or particulate mixture; (b) a mixture grinding step including grinding the mixture to a diameter of 15-20 μm, obtaining uniformly mixed glass fluorescent powder; (c) a hot pressing formation step including hot pressing the glass fluorescent powder into a glass phosphor at a temperature of 500-1000° C.; and (d) a processing formation step including grinding and polishing the glass phosphor into a lens.

The glass material in the mixing step can be obtained by: (a1) a low temperature sintering step including placing a glass in a container and carrying out low temperature sintering at a temperature of 1000-1500° C.; (a2) a quenching formation step including placing the glass into water, alcohol, or liquid nitrogen to cool the glass, forming the glass material after the glass is cooled; and (a3) a grinding step including grinding the glass material to a diameter of 15-20 μm.

The fluorescent powder can be a fluorescent material selected from the group consisting of yttrium aluminum garnet (YAG), nitride, and silicate, and the glass material can be selected from the group consisting of a silicate system, a phosphor system, a borate system, and a tellurate system.

The glass material can include 70 wt % of SiO₂, 20 wt % of Na₂O, 7 wt % of Al₂O₃, and 3 wt % of CaO.

In another aspect, a low temperature glass phosphor lens is produced by the method, wherein the fluorescent powder is a fluorescent material selected from the group consisting of yttrium aluminum garnet (YAG), nitride, and silicate, and wherein the glass material is selected from the group consisting of a silicate system, a phosphor system, a borate system, and a tellurate system.

The lens can be a plane lens, an aspheric lens, or a microlens.

In an embodiment, a polymethylmethacrylate (PMMA) lens is boned to the lens.

In embodiments, the lens extends across two ends of a substrate, and a chip is mounted between the substrate and the lens. The chip is adapted for generating a light source, and the light source emits outward through the lens.

The advantages of the method for producing a low temperature glass phosphor lens and the lens produced by the method are that the silica gel of the prior art is replaced with the glass material to mix and sinter with the fluorescent powder, forming a glass phosphor including characteristics of both of glass and fluorescence. Thus, the glass phosphor can be used as an LED packing material that is less easily to age under the heat energy from the chip of an LED. Furthermore, the processing temperature is controlled to be below 1000° C., which not only reduces the equipment costs but keeps the structure of the fluorescent powder in a stable state.

The present invention will become clearer in light of the following detailed description of illustrative embodiments of this invention described in connection with the drawings.

### BRIEF DESCRIPTION OF THE DRAWINGS

FIG. 1 shows a diagrammatic cross sectional view of a white light emitting diode including a conventional LED module packaging structure.

FIG. 2 is a diagrammatic cross sectional view of a low temperature glass phosphor lens of an embodiment according to the present invention.

FIG. 3 is a diagrammatic cross sectional view of a low temperature glass phosphor lens of another embodiment according to the present invention.

FIG. 4 is a diagrammatic cross sectional view of a low temperature glass phosphor lens of a further embodiment according to the present invention.

FIG. 5 is a diagrammatic cross sectional view of a low temperature glass phosphor lens of still another embodiment according to the present invention.

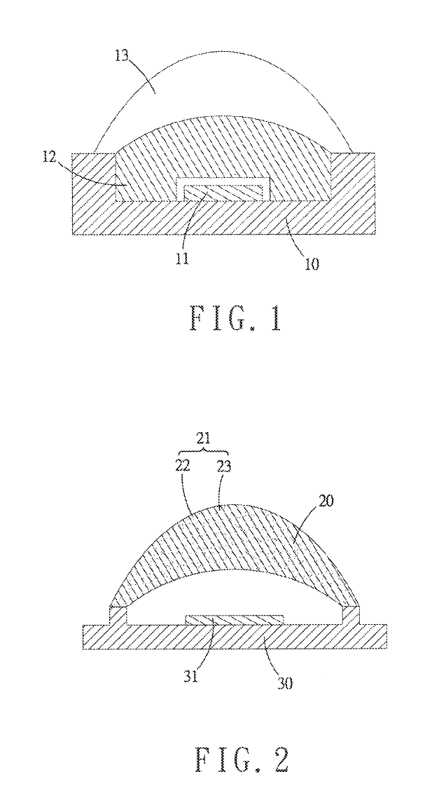

### DETAILED DESCRIPTION OF THE INVENTION

A method for producing a low temperature glass phosphor lens and a lens 20 produced by the method will now be set forth in connection with the accompanying drawings wherein like elements are designated by like reference numbers.

With reference to FIG. 2, the lens 20 is formed by a glass phosphor 21. The glass phosphor 21 is formed by sintering a glass material 22 and fluorescent powder 23. The fluorescent powder 23 is a fluorescent material selected from the group consisting of yttrium aluminum garnet (YAG), nitride, and silicate. The glass material 22 is selected from the group consisting of a silicate system, a phosphor system, a borate system, and a tellurate system.

Diffusion can be reduced when the stable crystalline structure of the fluorescent powder including yttrium aluminum garnet is sintered together with amorphous soda glass, maintaining good optical characteristics. Furthermrore, addition of nitride and silicate increases the color rendering index (Ra). The glass according to the present invention is soda glass that is highly resistive to corrosion and heat after modification to the properties. The fluorescent powder is selected from the group consisting of yttrium aluminum garnet, nitride, and silicate, forming an optical material with a wide color gamut and an adjustable color gamut.

Preferably, the glass material includes 70 wt % of SiO₂, 20 wt % of Na₂O, 7 wt % of Al₂O₃, and 3 wt % of CaO. Since the proportion of silicon dioxide is increased, the glass structure can be more stable. Furthermore, the composition is modified by adding calcium oxide for the purposes of preparing an organic glass material with high reliability. This prevents easy hydrolysis and fogging resulting from a loose glass structure and, thus, avoids degradation of the transmittance of the glass and resultant adverse effects on the optical characteristics of the glass phosphor lens.

As for implementation of the present invention, please refer to FIG. 2. The low temperature glass phosphor lens includes a substrate 30, a chip 31, and a lens 20. The chip 31 is mounted to the substrate 30 and is adapted for generating a light source.

The lens 20 is a curvature structure with a curved face and extends across two ends of the substrate 30. The chip 31 is received between the substrate 30 and the lens 20. The light source generated by the chip 31 emits outward through the lens 20.

The method for producing a low temperature glass phosphor lens according to the present invention is carried out by using the glass material 22 and the fluorescent powder 23. The method includes:

(a) a mixing step: the glass material 22 and the fluorescent powder 23 are mixed by dry mixing to form a powdery or particulate mixture. As an example, the glass material 22 and the fluorescent powder 23 are placed in a rotational mixer and are stirred and mixed for 30-60 minutes to obtain the mixture.

(b) a mixture grinding step: the mixture is grinded to a diameter of 15-20 μm, obtaining uniformly mixed glass fluorescent powder. As an example, the mixture is grinded in a mortar for 20-30 minutes to obtain the glass fluorescent powder. Thus, the particle size of the mixture after grinding can match the particle size of the fluorescent powder, providing an optical proportion of mixing and melting. In addition to excellent fluorescent uniformity, an appropriate surface area of the glass fluorescent powder can be obtained to effectively reduce the diffusion during contact sintering between the glass powder and the fluorescent powder, thereby reducing the quantum efficiency.

(c) a hot pressing formation step: the glass fluorescent powder is hot pressed into a glass phosphor 21 at a temperature of 500-1000° C.; and

(d) a processing formation step: the glass phosphor 21 is grinded and polished into a lens 20.

The glass material 22 in the mixing step can be obtained by:

(a1) a low temperature sintering step: glass is placed in a container, and low temperature sintering is carried out at a temperature of 1000-1500° C.;

(a2) a quenching formation step: the glass is placed into water, alcohol, or liquid nitrogen to cool the glass, forming the glass material 22 after the glass is cooled; and

(a3) a grinding step: the glass material 22 is grinded to a diameter of 15-20 μm.

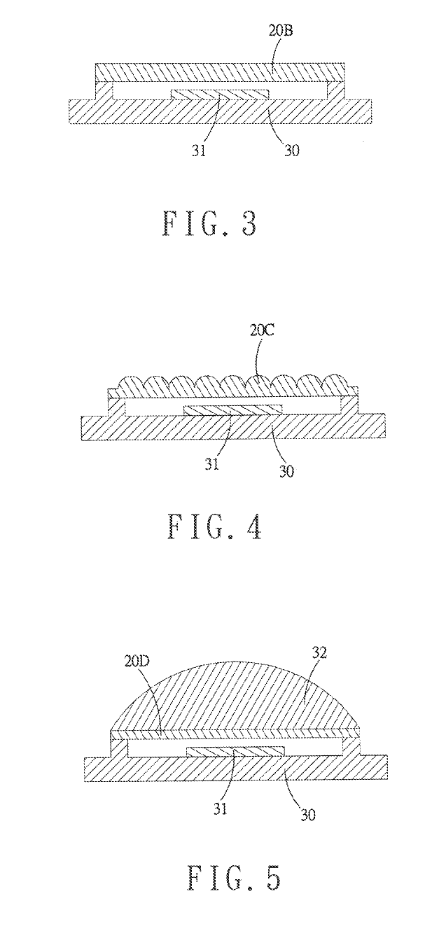

The structural type of the lens 20 can be different according to actual needs. The lens 20 can be a single glass phosphor lens or can cooperate with an optical film with light field correction characteristics. In the embodiment shown in FIG. 2, it is a lens 20 of a single aspheric, curved glass phosphor. In another embodiment shown in FIG. 3, it is a lens 20B of a single plane glass phosphor. In a further embodiment shown in FIG. 4, it is a lens 20C of a microlens glass phosphor. In still another embodiment shown in FIG. 5, it is a lens 20D of a glass phosphor, and a polymethylmethacrylate (PMMA) lens 32 is boned to a side of the lens 20D. Thus, the light extraction efficiency, the average color temperature, and the color gamut can be increased by cooperating with the curvature of the glass phosphor.

The present invention replaces the silica gel of the prior art with the glass material 22 to mix and sinter with the fluorescent powder 23, forming a glass phosphor 21 including characteristics of both of glass and fluorescence. Thus, the glass phosphor 21 can be used as an LED packing material that is less easily to age under the heat energy from the chip of an LED. Furthermore, the processing temperature is controlled to be below 1000° C., which not only reduces the equipment costs but keeps the structure of the fluorescent powder 23 in a stable state. Furthermore, by mixing the fluorescent powder 23 with the glass material 22, functions of both of a color change medium and a lens can be obtained. Thus, effects of color change and light field correction can be obtained.

Although specific embodiments have been illustrated and described, numerous modifications and variations are still possible without departing from the scope of the invention. The scope of the invention is limited by the accompanying claims.

What is claimed is:

1. A method for producing a low temperature glass phosphor lens, comprising:
dry mixing a glass material and fluorescent powder to form a powdery or particulate mixture;
grinding the mixture to a diameter of 15-20 μm, obtaining uniformly mixed glass fluorescent powder;
hot pressing the glass fluorescent powder into a glass phosphor at a temperature of 500-1000° C.; and
grinding and polishing the glass phosphor into a lens.

2. The method for producing the low temperature glass phosphor lens as claimed in claim 1, with the glass material being obtained by:
placing a glass in a container and carrying out low temperature sintering at a temperature of 1000-1500° C.;
placing the glass into water, alcohol, or liquid nitrogen to cool the glass, forming the glass material after the glass is cooled; and
grinding the glass material to a diameter of 15-20 μm.

3. The method for producing the low temperature glass phosphor lens as claimed in claim 1, wherein the fluorescent powder is a fluorescent material selected from the group consisting of yttrium aluminum garnet (YAG), nitride and silicate, and wherein the glass material is selected from the group consisting of a silicate system, a phosphor system, a borate system and a tellurate system.

4. The method for producing the low temperature glass phosphor lens as claimed in claim 3, wherein the glass material includes 70 wt % of SiO₂, 20 wt % of Na₂O, 7 wt % of Al₂O₃, and 3 wt % of CaO.

5. A low temperature glass phosphor lens produced by the method of claim 1, wherein the fluorescent powder is a fluorescent material selected from the group consisting of yttrium aluminum garnet (YAG), nitride and silicate, and wherein the glass material is selected from the group consisting of a silicate system, a phosphor system, a borate system, and a tellurate system.

6. The low temperature glass phosphor lens as claimed in claim 5, wherein the lens is a plane lens, an aspheric lens, or a microlens.

7. The low temperature glass phosphor lens as claimed in claim 5, further comprising a polymethylmethacrylate (PMMA) lens boned to the lens.

8. The low temperature glass phosphor lens as claimed in claim 5, with the lens extending across two ends of a substrate, with a chip mounted between the substrate and the lens, with the chip adapted for generating a light source, and with the light source emitting outward through the lens.
